(19) United States
(12) Patent Application Publication
(10) Pub. No.: US 2009/0295577 A1
(43) Pub. Date: Dec. 3, 2009

(54) Area Monitoring Sensor

(75) Inventor: Akiji Yamaguchi, Osaka (JP)

Correspondence Address: KILYK & BOWERSOX, P.L.L.C., 400 HOLIDAY COURT, SUITE 102, WARRENTON, VA, 20186, US

(73) Assignee: KEYENCE CORPORATION, Osaka (JP)

(21) Appl. No.: 12/427,265

(22) Filed: Apr. 21, 2009

(30) Foreign Application Priority Data
Jun. 3, 2008 (JP) 2008-145296

(51) Int. Cl. G08B 13/18

(52) U.S. Cl. 340/541

(57) ABSTRACT

Provided is an area monitoring sensor capable of recording sensing information of an intruder that has triggered to output an operation disable signal, and displaying the information as needed. The area monitoring sensor includes: an intruder sensing unit that emits detection light in different emitting directions and senses an intruder within a previously set monitor area based on reflection of the detection light; a signal output unit that outputs an operation disable signal based on a result of the sensing by the intruder sensing unit; a sensing history recording unit that stores a position of the intruder that has been sensed by the intruder sensing unit as sensing history; and a sensing history display unit that displays the sensing history in the sensing history recording unit based on an input signal from the operation input unit.

### CROSS-REFERENCE TO RELATED APPLICATIONS

The present application claims foreign priority based on Japanese Patent Application No. 2008-145296, filed Jun. 3, 2008, the contents of which is incorporated herein by reference.

### BACKGROUND OF THE INVENTION

1. Field of the Invention

The present invention relates to an area monitoring sensor, and in particular, to an improvement of an area monitoring sensor that emits detection light in different directions and senses an intruder within a previously set monitor area based on reflection of the detection light.

2. Description of the Related Art

An area monitoring sensor has been known as a sensor that senses an intruder such as a person entered into a no entrance area and outputs an operation disable signal. The area monitoring sensor includes, for example, a light projecting unit that projects detection light, a scanning unit that scans the detection light, and a light receiving unit that receives the detection light reflected on the intruder, and a distance and a direction toward the intruder are sensed based on an output from the light receiving unit. Then, based on a result of the sensing, it is determined whether or not the intruder is present within a predetermined area, and the operation disable signal is outputted based on a result of the determination. This operation disable signal is used, for example, as a control signal that stops a machine tool working near the monitored area.

While some of such conventional area monitoring sensors store an error history of failures and abnormal events that have occurred, none of them stores sensing information about the intruder that has triggered to output an operation disable signal. As a result, it is adversely difficult to obtain detailed knowledge as to what caused the sensor to output the operation disable signal.

### SUMMARY OF THE INVENTION

In view of the above problems, an object of the present invention is to provide an area monitoring sensor capable of recording sensing information about an intruder that has caused the sensor to output an operation disable signal, and displaying the information as needed.

An area monitoring sensor according to a first aspect of the present invention includes: an intruder sensing unit that emits detection light in different emitting directions and senses an intruder within a previously set monitor area based on reflection of the detection light; a signal output unit that outputs an operation disable signal based on a result of the sensing by the intruder sensing unit; a sensing history recording unit that stores a position of the intruder that has been sensed by the intruder sensing unit as sensing history; and a sensing history display unit that displays the sensing history based on an operation input. According to such a configuration, the position of the intruder that has been sensed by the intruder sensing unit is stored as the sensing history, and the sensing history is displayed based on the operation input. Therefore, it is possible to record the sensing information of the intruder that has triggered to output the operation disable signal, and display the information as needed.

In the area monitoring sensor according to a second aspect of the present invention, in addition to the above configuration, the sensing history recording unit stores the position of the intruder represented in Cartesian coordinates centering the area monitoring sensor as the sensing history.

In the area monitoring sensor according to a third aspect of the present invention, in addition to the above configuration, the sensing history recording stores the position of the intruder represented in polar coordinates centering the area monitoring sensor as the sensing history.

In the area monitoring sensor according to a fourth aspect of the present invention, in addition to the above configuration, the sensing history recording unit stores time at which the intruder has been sensed in association with the sensing history.

According to the area monitoring sensor of the present invention, the position of the intruder is stored as the sensing history, and the sensing history is displayed based on the operation input. Therefore, it is possible to record the sensing information of the intruder that has triggered to output the operation disable signal, and display the information as needed.

### BRIEF DESCRIPTION OF THE DRAWINGS

FIG. 1 is a perspective view illustrating one configurational example of a sensing system including an area monitoring sensor according to a first embodiment of the present invention, in which a light scanning safety sensor 1 is shown;

FIGS. 2A and 2B are diagrams each illustrating a configurational example of the safety sensor 1 of the sensing system shown in FIG. 1;

FIG. 3 is a transition diagram illustrating a configurational example of the safety sensor 1 shown in FIG. 2, in which screens 31 to 33 that are displayed in an operating mode, a monitoring mode, and a setting mode are shown;

FIG. 4 is a transition diagram illustrating a configurational example of the safety sensor 1 shown in FIG. 2, in which one example of screens that can be switched during the setting mode is shown;

FIG. 5 is a transition diagram illustrating a configurational example of the safety sensor 1 shown in FIG. 2, in which one example of screens that can be switched during the monitoring mode is shown;

FIG. 6 is a diagram illustrating one example of an operation of the safety sensor 1 shown in FIG. 2, in which changeable parameters B1 to B3 as an area size are shown;

FIGS. 7A to 7C are diagrams each illustrating one example of an operation in an area size setting of the safety sensor 1 shown in FIG. 2, in which an input screen when setting a size of a monitor area is shown; and

FIG. 8 is a block diagram illustrating a configurational example of the safety sensor 1 shown in FIG. 2, in which one example of a functional configuration in the safety sensor 1 is shown.

### DETAILED DESCRIPTION OF THE PREFERRED EMBODIMENTS

### Sensing System

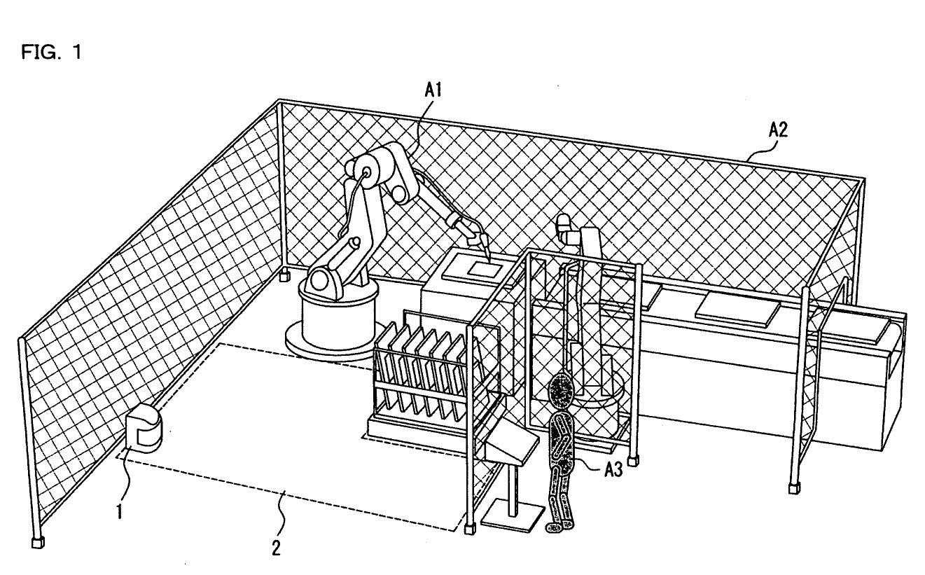

FIG. 1 is a perspective view illustrating one configurational example of a sensing system including an area monitoring sensor according to an embodiment of the present invention, in which a light scanning safety sensor 1 is shown as one example of the area monitoring sensor. In the sensing system, machines such as a carrier machine and a machining robot A1 are placed within an area that is partitioned by a safety barrier A2, an area around machinery and equipment such as a work area of the robot is set a monitor area 2, and an intruder within the monitor area 2 is sensed by the safety sensor 1.

The safety sensor 1 monitors the monitor area 2 having a complex shape by scanning detection light over the area, senses presence of an intruder such as an operator A3 who operates a control panel of the machinery and equipment, and outputs an operation disable signal. The sensing of the intruder is carried out based on reflection of the detection light on the intruder by emitting the detection light in different emitting directions.

The operation disable signal is used, for example, as a control signal that stops the machining robot A1 working near the monitor area 2. Specifically, the safety sensor 1 includes an output signal switching device (OSSD) output, and outputs an operation enable signal when no intruder is present within the monitor area 2 (OSSD ON status) and an operation disable signal when any intruder is present within the monitor area 2 (OSSD OFF status).

### Area Monitoring Sensor

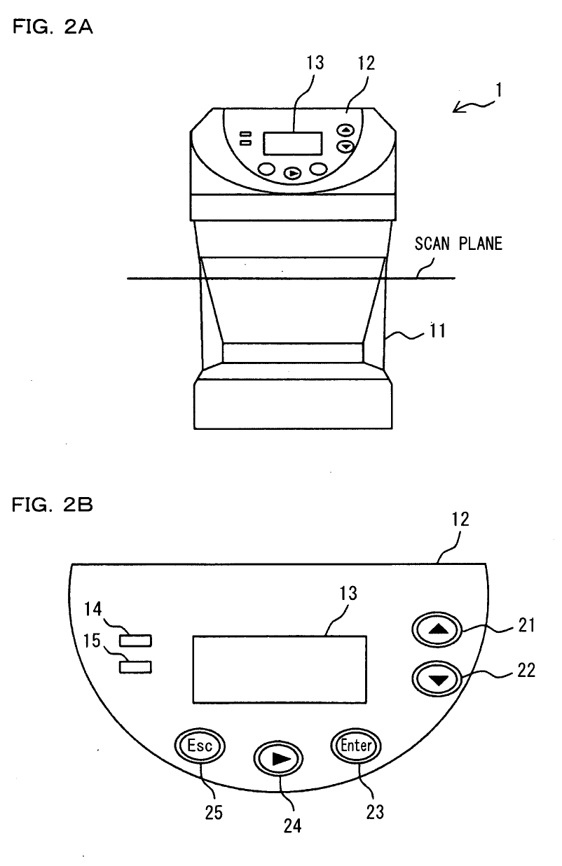

FIGS. 2A and 2B are diagrams each illustrating a configurational example of the safety sensor 1 of the sensing system shown in FIG. 1. In FIG. 2A, the sensor is shown from a front side thereof, and in FIG. 2B, an operation panel 12 provided for the safety sensor 1 is shown.

The safety sensor 1 is a light scanning area monitoring sensor that senses an intruder within the monitor area 2 by scanning the detection light across a horizontal scan plane. The safety sensor 1 is configured by, for example, a light projecting unit that projects the detection light, a scanning unit that scans the detection light in horizontal direction repeatedly at a constant interval, a light receiving unit that receives the detection light reflected on the intruder, a sensing unit that senses the intruder within the monitor area 2 based on a result of the reception of the detection light, and an output unit that outputs the operation disable signal based on a result of the sensing.

As the detection light, for example, a laser beam of a wavelength in an infrared range is used. The monitor area 2 in a horizontal plane is monitored by scanning the detection light in horizontal direction, and the intruder within the monitor area 2 is sensed by the reception of light reflected from the intruder.

Specifically, a distance between the safety sensor 1 and the intruder is calculated based on a light projecting timing of the detection light and a light receiving timing of the detection light reflected on the intruder. Further, a direction of the intruder is calculated by determining the emitting direction of the detection light based on the control signal of the scanning unit. Then, it is determined whether or not the intruder is present within the monitor area 2 based on the calculated distance and direction, and the detection signal is outputted based on a result of the determination.

The safety sensor 1 includes a cover 11 that covers the light projecting unit, the scanning unit, the light receiving unit and the like, and the operation panel 12. The operation panel 12 is provided with a plurality of operation keys 21 to 25, a display 13, and LED indicators 14 and 15.

The operation keys 21 to 25 are contact type tact switches used for inputting a value or selecting a menu when setting the monitor area. The operation keys 21 and 22 are for inputting a value or switching a screen. For example, the operation key 21 can be used as an up key for incrementing a value. Further, the operation key 22 can be used as a down key for decrementing a value.

The operation keys 23 to 25 are for switching between the working modes and confirming the setting values. For example, the operation key 23 is an enter key (Enter), the operation key 24 is a mode switching key, and the operation key 25 is an escape key (Esc).

The display 13 is a display unit for displaying sensing information of an intruder and operation input information, and for example, a liquid crystal display capable of displaying 12 characters×4 lines is used.

The LED indicators 14 and 15 are display units each indicating an operation status by a LED (light emitting diode). The LED indicator 14 indicates an OSSD output, and the LED indicator 15 indicates whether or not a main body of the sensor is in an interlock status.

### Working Mode

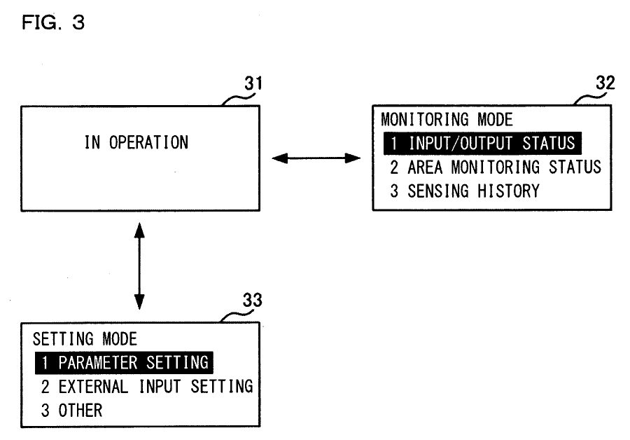

FIG. 3 is a transition diagram illustrating a configurational example of the safety sensor 1 shown in FIG. 2, in which screens 31 to 33 that are displayed on the display 13 in an operating mode, a monitoring mode, and a setting mode are shown. The screen 31 is a screen in the operating mode, and the screen 32 is a menu screen in the monitoring mode.

The operating mode is the working mode in which an intruder within the monitor area 2 is sensed and the detection signal is outputted. The monitoring mode is the working mode in which an input/output status, an area monitoring condition, a sensing history, and the like are displayed. As the input/output status, an OSSD output status, an input status of an external relay circuit, and the like can be monitored. As the area monitoring condition, a shape and a size of the monitor area that has been set, a distance to the intruder that has been sensed, and the like can be monitored. As the sensing history, a position and sensing time of the intruder that has triggered to output the operation disable signal, error information, and the like are stored as the sensing history during the OSSD OFF, and can be displayed as needed.

It is possible to switch from the operating mode to the monitoring mode by operating the operation key 23, for example. Further, operating the operation key 25 in the monitoring mode, for example, allows the mode to return to the operating mode.

In the screen 32, selectable menu items are arranged, and the menu items to be displayed can be altered by operating the operation keys 21 and 22, for example.

The screen 33 is a menu screen in the setting mode. The setting mode is the working mode in which parameters for specifying the monitor area and external input are set. It is possible to switch from the operating mode to the setting mode by operating the operation key 24, for example. Further, operating the operation key 24 again in the setting mode allows the mode to return to the operating mode.

In the screen 33, selectable menu items are arranged, and a desired menu item can be selected by operating the operation keys 21 and 22, for example.

### Setting Mode

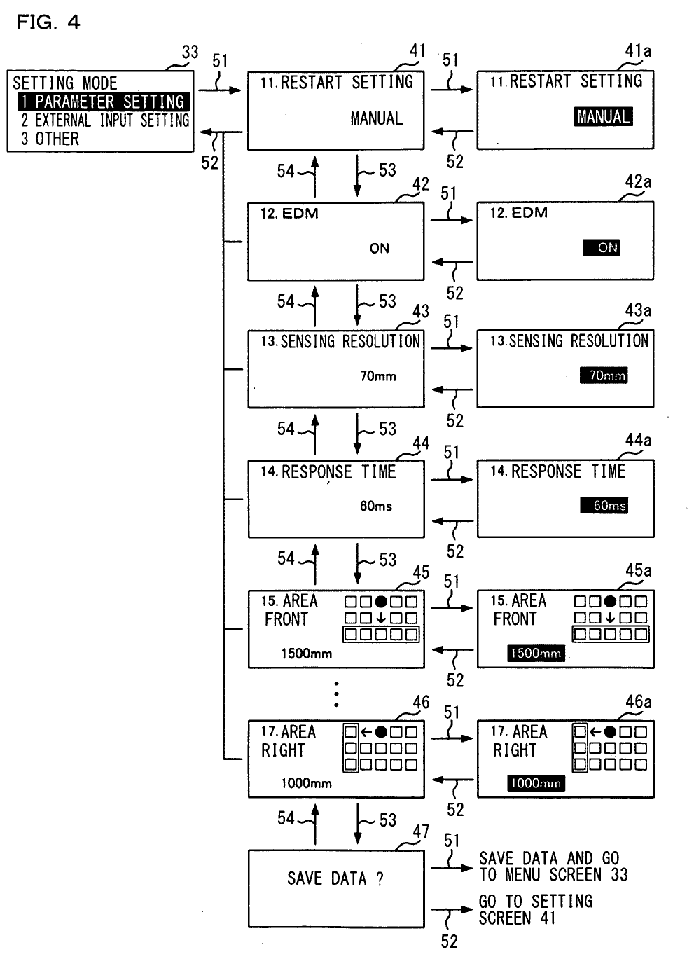

FIG. 4 is a transition diagram illustrating a configurational example of the safety sensor 1 shown in FIG. 2, in which one example of screens that can be switched during the setting mode is shown. In the setting mode, by selecting a menu item “1 Parameter Setting” on the screen 33 and carrying out an operation 51 by the operation key 23, screens 41 to 46 for setting the parameters can be displayed.

The setting screens 41 to 46 are screens for setting operation parameters when sensing the intruder, and restart setting, EDM, sensing resolution, response time, and the size of the monitor area are provided as changeable parameters. The setting screen 41 is the setting screen first displayed by the operation 51, and the setting screens 42 to 46 can be sequentially displayed by carrying out the operation 53 by operating the operation key 22. Further, when the setting screens 41 to 46 are displayed, carrying out the operation 52 by operating the operation key 25 allows the screen to return to the menu screen 33.

The setting screen 41 is the screen for setting a parameter for restart, with which it is possible to select whether the sensor main body is to be restarted manually or automatically. When the setting screen 41 is displayed, a screen 41a for inputting the parameter can be displayed by carrying out the operation 51 by operating the operation key 23. In the input screen 41a, the parameter can be altered by operating the operation keys 21 and 22. Further, carrying out the operation 52 by operating the operation key 25 allows the screen to return to the setting screen 41 without changing the parameter.

On the other hand, when the setting screen 41 is displayed, it is possible to switch to the setting screen 42 for setting the EDM by carrying out the operation 53 by operating the operation key 22. The setting screen 42 is the screen for setting a parameter for EDM, with which it is possible to select whether a function for external relay monitoring is to be turned on or off. When the setting screen 42 is displayed, a screen 42a for inputting the parameter can be displayed by carrying out the operation 51 by operating the operation key 23. Carrying out the operation 54 by operating the operation key 21 allows the screen to return to the setting screen 41.

When the setting screen 42 is displayed, it is possible to switch to the setting screen 43 for setting the sensing resolution by carrying out the operation 53 by operating the operation key 22. The setting screen 43 is the screen for setting a parameter relating to the resolution when sensing the intruder, with which it is possible to arbitrarily specify the resolution within a predetermined range. When the setting screen 43 is displayed, a screen 43a for inputting the parameter can be displayed by carrying out the operation 51 by operating the operation key 23. Carrying out the operation 54 by operating the operation key 21 allows the screen to return to the setting screen 42.

When the setting screen 43 is displayed, it is possible to switch to the setting screen 44 for setting the response time by carrying out the operation 53 by operating the operation key 22. The setting screen 44 is the screen for setting a parameter relating to the response time when sensing the intruder, with which it is possible to arbitrarily specify the response time within a predetermined range. When the setting screen 44 is displayed, a screen 44a for inputting the parameter can be displayed by carrying out the operation 51 by operating the operation key 23. Carrying out the operation 54 by operating the operation key 21 allows the screen to return to the setting screen 43.

When the setting screen 44 is displayed, it is possible to switch to the setting screen 45 for setting the monitor area by carrying out the operation 53 by operating the operation key 22. The setting screen 45 is the screen for setting a distance to a front boundary as the size of the monitor area, with which it is possible to arbitrarily specify the distance within a predetermined range. When the setting screen 45 is displayed, a screen 45a for inputting the parameter can be displayed by carrying out the operation 51 by operating the operation key 23. Carrying out the operation 54 by operating the operation key 21 allows the screen to return to the setting screen 44.

When the setting screen 45 is displayed, it is possible to switch to the setting screen for setting a distance to a left boundary as the size of the monitor area by carrying out the operation 53 by operating the operation key 22. Further, when this setting screen is displayed, it is possible to switch to a setting screen 46 for setting a distance to a right boundary as the size of the monitor area by carrying out the operation 53 by operating the operation key 22. When the setting screen 46 is displayed, a screen 46a for inputting the parameter can be displayed by carrying out the operation 51 by operating the operation key 23.

When the setting screen 46 is displayed, it is possible to switch to a save screen 47 for confirming setting values for the parameters by carrying out the operation 53 by operating the operation key 22. When the save screen 47 is displayed, the setting values for the parameters are confirmed by carrying out the operation 51 by operating the operation key 23, and then it is possible to switch to the menu screen 33 after saving the setting values in a memory. On the other hand, carrying out the operation 52 by operating the operation key 25 without confirming the setting values for the parameters allows the screen to return to the setting screen 41.

### Monitoring Mode

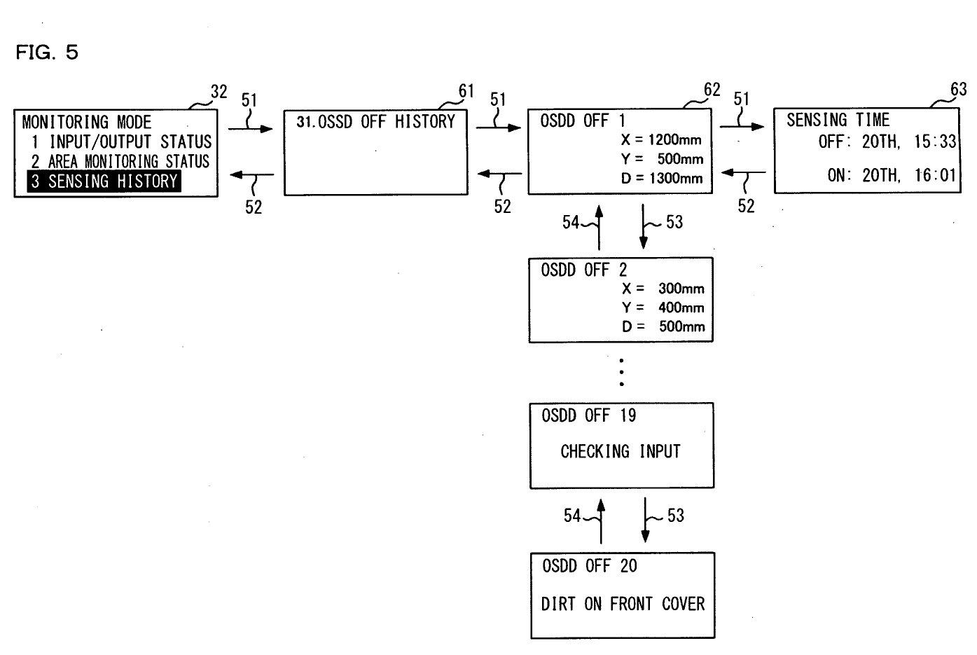

FIG. 5 is a transition diagram illustrating a configurational example of the safety sensor 1 shown in FIG. 2, in which one example of screens that can be switched during the monitoring mode is shown. In the monitoring mode, by selecting a menu item “3 Sensing History” on the screen 32 and carrying out the operation 51 by operating the operation key 23, browsing screens 61 to 63 for browsing the sensing history can be displayed.

The browsing screens 61 to 63 are screens for displaying the sensing history during the OSSD OFF. The browsing screen 61 is a history monitoring screen that is first displayed by the operation 51, from which the browsing screen 62 can be displayed by carrying out the operation 51 by operating the operation key 23. Further, when the browsing screen 62 is displayed, carrying out the operation 52 by operating the operation key 25 allows the screen to return to the menu screen 32.

The browsing screen 62 displays the position information of the intruder that has triggered to output the operation disable signal and the error information. The browsing screen 62 is displayed for each event that has triggered to output the operation disable signal, and the screens can be switched between each other by operating the operation keys 21 and 22. The sensing history can be displayed in order starting from the latest event. Such sensing history can be stored up to 20 events, and the oldest event is cleared when a new event for the sensing history is obtained.

As the position information of the intruder, for example, a value indicating the position of the intruder is displayed in Cartesian coordinates centering the safety sensor 1. Further, a value indicating a distance D between the safety sensor 1 and the intruder is displayed.

Moreover, as the error information, for example, information indicating an occurrence of a failure such as dirt on front cover or an output short-circuit is displayed. Further, the history information that can be displayed in the browsing screen 62 includes, in addition to the position information and the error information, information that indicates a checking input from the external device. This checking input is an external input for confirming whether or not the OSSD is correctly turned off.

By carrying out the operation 51 by operating the operation key 23 while the browsing screen 62 that displays the position information of the intruder is displayed, it is possible to switch to the browsing screen 63 of the sensing time. The browsing screen 63 displays information of time at which OSSD is turned off as date and time of sensing and information of time at which OSSD is then turned on.

### Monitor Area

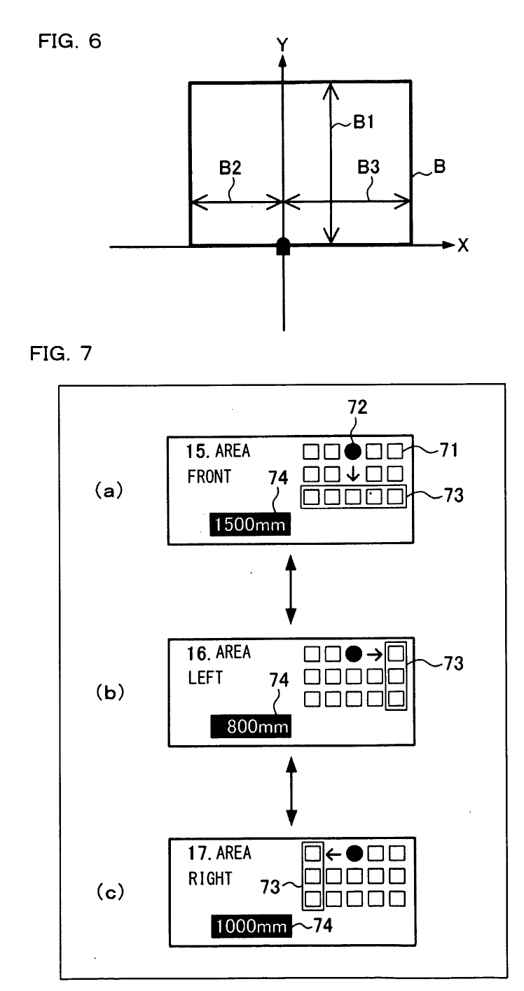

FIG. 6 is a diagram illustrating one example of an operation of the safety sensor 1 shown in FIG. 2, in which changeable parameters B1 to B3 as an area size are shown when the monitor area is set as the rectangular area B. The area B as the monitor area is a rectangular area defined by four sides, and the safety sensor 1 is provided on one of the four sides.

In this example, the size of the monitor area can be specified using Cartesian coordinates centering the safety sensor 1 with one coordinate axis (X axis) provided along the one side of the area B and the other coordinate axis (Y axis) provided along the forward direction of the safety sensor 1.

Specifically, a distance to a boundary line (front boundary line) of the area B positioned on a forward side with respect to the safety sensor 1 can be specified as the parameter B1. The parameter B1 represents the distance between the X axis and the front boundary line.

Further, a distance to a boundary line (left boundary line) of the area B positioned on a left side with respect to the safety sensor 1 can be specified as the parameter B2. The parameter B2 represents the distance between the Y axis and the left boundary line. Further, a distance to a boundary line (right boundary line) of the area B positioned on a right side with respect to the safety sensor 1 can be specified as the parameter B3. The parameter B3 represents the distance between the Y axis and the right boundary line.

FIGS. 7A to 7C are diagrams each illustrating one example of the operation in an area size setting of the safety sensor 1 shown in FIG. 2, in which an input screen when setting the size of the monitor area is shown. FIG. 7A shows the input screen when setting the distance to the front boundary line. In this input screen, the shape of the monitor area is graphically displayed using the plurality of symbols. Specifically, the monitor area is displayed using the symbols 71 that are arranged in a matrix of three lows and four columns. In other words, the monitor area is displayed by the plurality of symbols that are adjacent to at least the sides on which the safety sensor 1 is not provided out of the four sides that define the monitor area.

In this example, the short side of the area B is represented by three symbols 71, and the long side is represented by five symbols 71. Further, the safety sensor 1 is provided at a center of the long side, at which a symbol 72 that represents the safety sensor 1 is displayed.

Further, the side selection unit 62 displays the side that is being selected distinguishably from the other sides. Specifically, the front boundary line of the area B is selected, and indicated as the side that is being selected by a box 73 that encloses the five symbols 71 positioned along the long side which is the front boundary line.

In this input screen, a display section 74 for displaying the setting value (numeric value) for the distance is provided, and it is possible to change the setting value for the distance to the front boundary line “1500 mm” by operating the operation keys 21 and 22. The symbols for showing the shape of the monitor area are disposed on a right side within the input screen, and the display section is on a lower left within the input screen.

FIG. 7B shows the input screen when setting the distance to the left boundary line. In this input screen, the left boundary line of the area B is selected, and indicated as the side that is being selected by the box 73 that encloses the three symbols 71 positioned along the short side which is the left boundary line.

In this input screen, the display section 74 for displaying the setting value (numeric value) for the distance is provided, and it is possible to change the setting value for the distance to the left boundary line “800 mm” by operating the operation keys 21 and 22.

FIG. 7C shows the input screen when setting the distance to the right boundary line. In this input screen, the right boundary line of the area B is selected, and indicated as the side that is being selected by the box 73 that encloses the three symbols 71 positioned along the short side which is the right boundary line.

In this input screen, the display section 74 for displaying the setting value (numeric value) for the distance is provided, and it is possible to change the setting value for the distance to right boundary line “1000 mm” by operating the operation keys 21 and 22.

### Functional Configuration

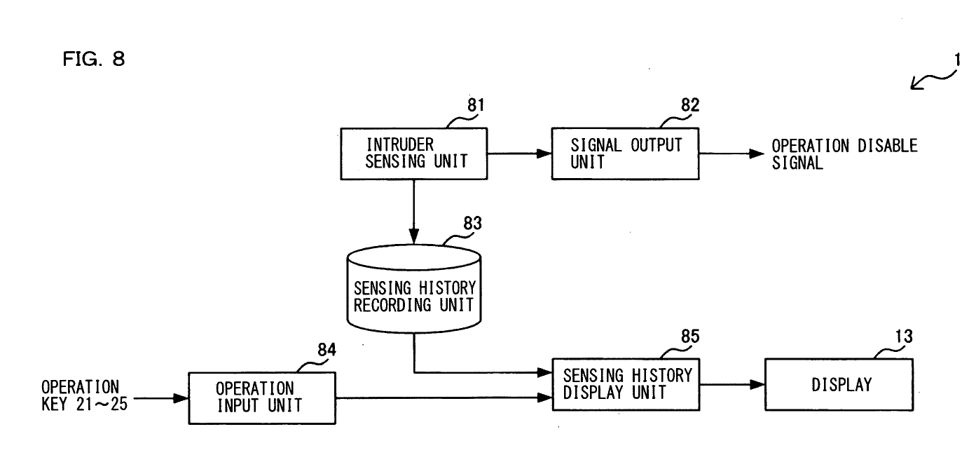

FIG. 8 is a block diagram illustrating a configurational example of the safety sensor 1 shown in FIG. 2, in which one example of functional configurations in the safety sensor 1 is shown. The safety sensor 1 is provided with, in addition to the operation keys 21 to 25 and the display 13, an intruder sensing unit 81, a signal output unit 82, a sensing history recording unit 83, an operation input unit 84, and a sensing history display unit 85.

The intruder sensing unit 81 emits the detection light in the different directions, and senses the intruder within the monitor area 2 that has been previously set based on reflection of the detection light.

The signal output unit 82 outputs the operation disable signal based on a result of the sensing by the intruder sensing unit 81. The sensing history recording unit 83 is a memory for storing the position of the intruder that has been sensed by the intruder sensing unit 81 as the sensing history.

The operation input unit 84 generates a predetermined input signal based on the operation of the operation keys 21 to 25. The sensing history display unit 85 controls the display 13, and displays the sensing history in the sensing history recording unit 83 based on the input signal from the operation input unit 84.

The sensing history recording unit 83 stores the position of the intruder represented in Cartesian coordinates centering the safety sensor 1 as the sensing history. Alternatively, the position of the intruder represented in polar coordinates centering the safety sensor 1 is stored as the sensing history.

Further, the sensing history recording unit 83 stores time information of the time at which the intruder has been sensed in association with the sensing history.

According to the present embodiment, the position of the intruder that has been sensed by the intruder sensing unit 81 is stored as the sensing history, and the sensing history can be displayed based on the operation input by the operator. Therefore, the sensing information of the intruder that has triggered to output the operation disable signal can be recorded and displayed as needed.

What is claimed is:

1. An area monitoring sensor, comprising:
an intruder sensing unit that emits detection light in different emitting directions and senses an intruder within a predetermined monitor area based on reflection of the detection light;
a signal output unit that outputs an operation disable signal based on a result of the sensing by the intruder sensing unit;
a sensing history recording unit that stores a position of the intruder sensed by the intruder sensing unit as sensing history; and
a sensing history display unit that displays the sensing history based on an operation input.

2. The area monitoring sensor according to claim 1, wherein the sensing history recording unit stores the position of the intruder represented in Cartesian coordinates centering the area monitoring sensor as the sensing history.

3. The area monitoring sensor according to claim 1, wherein
the sensing history recording stores the position of the intruder represented in polar coordinates centering the area monitoring sensor as the sensing history.

4. The area monitoring sensor according to claim 1, wherein
the sensing history recording unit stores time at which the intruder sensed in association with the sensing history.
